(19) United States
(12) Patent Application Publication
(10) Pub. No.: US 2026/0312220 A1
(43) Pub. Date: Oct. 8, 2026

(54) BATTERY MODULE, BATTERY PACK AND VEHICLE INCLUDING THE SAME

(71) Applicant: LG ENERGY SOLUTION, LTD., Seoul (KR)

(72) Inventors: Dong-Woo KIM, Daejeon (KR); Yoon-Oh Ko, Daejeon (KR); Hee-Yong Kwon, Daejeon (KR); Mi-Jeong Jang, Daejeon (KR)

(73) Assignee: LG ENERGY SOLUTION, LTD., Seoul (KR)

(21) Appl. No.: 19/468,636

(22) Filed: Feb. 3, 2026

(30) Foreign Application Priority Data
Feb. 4, 2025 (KR) 10-2025-0013539

(51) Int. Cl. H01M 50/342; H01M 50/249; H01M 50/276; H01M 50/282

(52) U.S. Cl. CPC H01M 50/3425; H01M 50/249; H01M 50/276; H01M 50/282; H01M 2200/20

(57) ABSTRACT

A battery module includes: a cell stack including a plurality of battery cells; a case that accommodates the cell stack and includes a top plate having at least one first venting portion configured to discharge venting gas; a flexible cover that is disposed on the case, and includes at least one second venting portion formed at a position corresponding to the first venting portion and configured to discharge venting gas; and a hard cover that is disposed on the flexible cover and is divided into a plurality of regions having different thicknesses.

### CROSS REFERENCES TO RELATED APPLICATIONS

This application is based on and claims priority from Korean Patent Application No. 10-2025-0013539, filed on Feb. 4, 2025, with the Korean Intellectual Property Office, the disclosure of which is incorporated herein in its entirety by reference.

### TECHNICAL FIELD

The present disclosure relates to a battery module, a battery pack and a vehicle including the same.

### BACKGROUND

Secondary batteries, which have high applicability across the product group and have electrical characteristics such as high energy density, are widely applied not only to the portable devices but also to the electric vehicles (EVs) or hybrid vehicles (HEVs) that are driven by electrical driving sources.

These secondary batteries are attracting attention as a new energy source for improving eco-friendliness and energy efficiency, not only because they have the primary advantage of drastically reducing the use of fossil fuels, but also because they produce no by-products from energy use.

The types of secondary batteries currently used widely include, for example, lithium ion batteries, lithium polymer batteries, nickel cadmium batteries, nickel hydrogen batteries, and nickel zinc batteries. When a high output voltage is required, a plurality of battery cells may be connected in series to form a battery module or a battery pack. In addition, in order to increase the charge/discharge capacity, a plurality of battery cells may be connected in parallel to form a battery module or a battery pack. Accordingly, the number of battery cells included in the battery module or pack may be variously set depending on the required output voltage, or charge and discharge capacity.

When configuring a battery pack by connecting a plurality of battery cells in series and/or in parallel, it is a common practice to first configure a battery module including at least one battery cell, and to configure a battery pack or a battery rack by adding other components using the at least one battery module. Recently, battery packs of a cell-to-pack type, in which a plurality of battery cells are accommodated directly in, for example, a pack housing without being modularized, have also been manufactured.

However, when a large number of battery modules are included inside a battery pack in this manner, the battery pack may be vulnerable to thermal chain reactions between the battery modules. In such a situation, concerns may be raised regarding the safety of the battery, and this remains as an issue that still needs to be addressed.

### SUMMARY

The present disclosure provides a battery module in which safety and reliability are improved by appropriately controlling a venting direction of, for example, high-temperature gas or flame generated from a battery cell in an abnormal situation of a battery module, and by preventing or suppressing the back-flow of external high-temperature gas or flame so as to effectively reducing thermal propagation between battery cells or between battery modules.

The present disclosure further provides a battery pack including a battery module having an improved structure, and a vehicle including the battery pack.

The technical features of the present disclosure are not limited to those described above, and other features that are not mentioned may be clearly understood by those ordinarily skilled in the art from the following description of the disclosure.

A battery module according to the present disclosure may include: a cell stack including a plurality of battery cells; a case that accommodates the cell stack and includes a top plate having at least one first venting portion configured to discharge venting gas; a flexible cover that is disposed on the case, and includes at least one second venting portion that is formed at a position corresponding to the first venting portion and discharges venting gas; and a hard cover that is disposed on the flexible cover and is divided into a plurality of regions having different thicknesses.

The hard cover may be divided into a first region that corresponds to the first venting portion and has a first thickness, and a second region that corresponds to a remaining region excluding the first region and has a second thickness greater than the first thickness.

On a lower surface of the hard cover facing the flexible cover, the first region may be recessed upward relative to the second region.

On the lower surface of the hard cover, pressure of venting gas exiting outward from the battery module may be applied only to the first region.

An upper surface of the hard cover opposite to a surface of the hard cover facing the flexible cover may be formed as a flat surface.

On the upper surface of the hard cover, pressure of venting gas entering inward from the outside of the battery module may be applied to the first region and the second region.

A contact area between venting gas exiting outward from the inside of the battery module and the hard cover may be smaller than a contact area between venting gas entering inward from the outside of the battery module and the hard cover.

A surface pressure acting on the hard cover by venting gas exiting outward from the inside of the battery module may be configured to be higher than a surface pressure acting on the hard cover by venting gas entering inward from the outside of the battery module.

The first region may be configured to be separated from the second region when a thermal event occurs in the battery cell.

The first region separated from the second region may be configured to cover at least a portion of the first venting portion when moved downward.

The first region may be configured to be separated from the second region by an external pressure, and the first region separated from the second region may be configured to cover at least a portion of the first venting portion when moved downward.

The first region may have a size larger than a size of the first venting portion.

At least one of the hard cover and the flexible cover may include a mica material.

The hard cover may be formed of a material having a higher hardness than the flexible cover.

The flexible cover may be configured to cover at least three surfaces of the case thereby protecting the battery cell in the battery module from venting the gas outside the battery module.

The flexible cover may include: an upper cover that covers an upper side of the case, the second venting portion being formed in the upper cover; a left cover that extends from the upper cover in a bendable manner and covers a left side of the case; and a right cover that extends from the upper cover so in a bendable manner and covers a right side of the case.

The battery module according to the present disclosure may further include: a first adhesive member disposed between the case and the flexible cover; and a second adhesive member disposed between the flexible cover and the hard cover.

The second venting portion may have a size larger than a size of the first venting portion.

In addition, the present disclosure provides a battery pack including the battery module according to the present disclosure.

Furthermore, the present disclosure provides a vehicle including the battery module according to the present disclosure.

According to an aspect of the present disclosure high-temperature gas or flame generated from a battery cell in the battery module may be guided upward for directional venting, so that the high-temperature gas or flame may be rapidly discharged to the outside. Accordingly, safety and reliability of the battery module may be further improved.

According to another aspect of the present disclosure, the back-flow of external high-temperature gas or flame into the inside of the battery module may be prevented or suppressed, thereby effectively preventing or delaying transfer of gas or flame from a battery module in which an event has occurred to an adjacent battery module to cause thermal runaway.

According to still another aspect of the present disclosure, the back-flow of high-temperature gas or flame discharged to the outside of the battery module into the inside of the battery module may be prevented or suppressed.

According to yet another aspect of the present disclosure, it is possible to prevent or delay an event caused by a thermal runaway phenomenon of a battery pack including a plurality of battery modules, or a device in which the battery pack is mounted, such as fire or explosion, may be prevented or delayed.

In addition, the present disclosure may provide various other effects, and descriptions of effects that are described in respective embodiments or that may be readily inferred by those skilled in the art will be omitted.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a front perspective view of a battery module, according to an embodiment of the present disclosure.

FIG. 2 is an exploded perspective view of the battery module, according to an embodiment of the present disclosure.

FIG. 3 is a cross-sectional view of the battery module of FIG. 1 taken along the line A-A′.

FIG. 4 is a view illustrating a state where the pressure of venting gas is applied in FIG. 3.

FIG. 5 is a view illustrating a state where a first pressure is applied to the battery module, according to an embodiment of the present disclosure.

FIG. 6 is a view illustrating a state where a second pressure is applied to the battery module, according to an embodiment of the present disclosure.

FIG. 7 is an unfolded view illustrating a state where a flexible cover of a battery module is unfolded, according to an embodiment of the present disclosure is unfolded.

FIG. 8 is a view illustrating a front view of a battery module, according to an embodiment of the present disclosure.

FIG. 9 is a graph illustrating a range of pressures at which a hard cover is ruptured when the first pressure is applied to a battery module, in a comparative example battery module and a battery module according to the present disclosure.

FIG. 10 is a graph illustrating a range of pressures at which a hard cover is ruptured when the second pressure is applied to a battery module, in a comparative example battery module and a battery module according to the present disclosure.

FIG. 11 is a cross-sectional view illustrating an upper side of a battery module according to another embodiment of the present disclosure, taken along the line A-A′ of FIG. 1.

FIG. 12 is a view illustrating a state where the second pressure is applied to the battery module, according to another embodiment of the present disclosure.

FIG. 13 is a cross-sectional view illustrating an upper side of a battery module, according to another embodiment of the present disclosure, taken along line A-A′ of FIG. 1.

FIG. 14 is a cross-sectional view illustrating an upper side of a battery module according to still another embodiment of the present disclosure, taken along the line A-A′ of FIG. 1.

FIG. 15 is a view illustrating a state where the second pressure is applied to the battery module, according to still another embodiment of the present disclosure.

FIG. 16 is a schematic perspective view of a battery pack including a battery module, according to an embodiment of the present disclosure.

FIG. 17 is a schematic perspective view of a vehicle including a battery pack, according to an embodiment of the present disclosure.

In some of the accompanying drawings, corresponding components will be denoted with the same reference numerals. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described with reference to the attached drawings. Prior to this, the terms or words used in the specification and claims should not be construed as being limited to their ordinary or dictionary meanings, but should be construed as having meanings and concepts consistent with the technical spirit of the present disclosure, based on the principle that an inventor may appropriately define the concepts of terms in order to explain the inventor’s own invention in the best manner.

Accordingly, since the embodiments described in this description and the configurations illustrated in the drawings are merely example embodiments of the present disclosure, and do not represent all of the technical ideas of the present disclosure, it should be understood that at the time of filing, there may be various equivalents and modifications that could serve as alternatives to the embodiments.

In addition, the present disclosure includes a variety of embodiments. For each embodiment, redundant descriptions for configurations that are substantially the same or similar are omitted, and the differences are mainly described.

In addition, in order to aid understanding of the present disclosure, the attached drawings are not drawn to scale and the dimensions of some components may be exaggerated. In addition, the same reference numbers may be assigned to the same components in different embodiments.

Although the terms such as first and second are used in order to describe various elements, the components are, of course, not limited by these terms. These terms are only used to distinguish one component from another component, and the first component may be, of course, the second component unless specifically stated otherwise.

Throughout the specification, unless specifically stated otherwise, each component may be singular or plural.

Hereinafter, when an arbitrary component is described as being disposed at the "upper (or lower)" of a component or "above (or below)" the component, it may mean that the arbitrary component is disposed in contact with the upper surface (or lower surface) of the component, as well as that another component may be interposed between the component and the arbitrary component disposed above (or below) the component.

In addition, when an arbitrary component is described as being "connected," "coupled," or "join" to another component, it should be understood that the components may be directly connected or joined to each other, but another component may be "interposed" between individual components or the individual components may be "connected," "coupled," or "joined" to each other via another component.

The singular forms used in the present specification include the plural forms unless the context clearly indicates otherwise. In the present application, the term, "composed of," "including," or the like should not be construed to mean that various constituent elements or steps described in the specification are necessarily included. It should be interpreted that some of the constituent elements or some steps may not be included, or that additional constituent elements or steps may be further included.

Throughout the description, when referred to as "A and/or B," this means A, B, or A and B unless specifically stated otherwise, and when referred to as "C to D," this means C or more and D or less unless specifically stated otherwise.

Meanwhile, in the present disclosure, terms indicating directions such as up, down, left, right, front, and rear may be used; however, such terms are merely for convenience of description, and it will be apparent to those ordinarily skilled in the art that the meanings of such terms may vary depending on, for example, the position of an object to be described or the position of an observer.

In an embodiment of the present disclosure, an X-axis direction illustrated in the drawings may indicate a left-right direction, a Y-axis direction may indicate a length direction of a battery cell, which is a front-rear direction perpendicular to the X-axis direction on a horizontal plane (X-Y plane), and a Z-axis direction may indicate an up-down direction (vertical direction) of the battery cell, which is a height direction perpendicular to both the X-axis direction and the Y-axis direction.

When a battery pack includes a large number of battery modules therein, the battery pack may be vulnerable to the thermal chain reactions between the battery modules. For example, when an event such as thermal runaway occurs inside one of the battery modules, the thermal runaway may propagate to another battery module. When propagation of thermal runaway between the battery modules is not properly suppressed, an event occurring in a specific battery module may cause a chain reaction of multiple battery modules, which may result in a serious problem such as an explosion or fire.

When a large number of battery cells are included in a battery module, high-temperature gas, flame, or spark generated during thermal runaway of a specific battery cell is highly likely to be discharged toward a front or rear side of battery cells in which electrode leads of the battery module are located.

Accordingly, when a thermal event occurs in any one of the battery cells, there is a need to develop a structure capable of preventing or suppressing discharge of high-temperature gas or flame discharged from the battery cell, or appropriately controlling a discharge direction thereof, and simultaneously preventing or suppressing the back-flow of external high-temperature gas or flame so as to delay the thermal runaway between battery cells or between battery modules.

In consideration of the above, the present disclosure provides a battery module capable of guiding high-temperature gas or flame generated from a battery cell to the upper side for directional venting, so that the high-temperature gas or flame may be rapidly discharged to the outside.

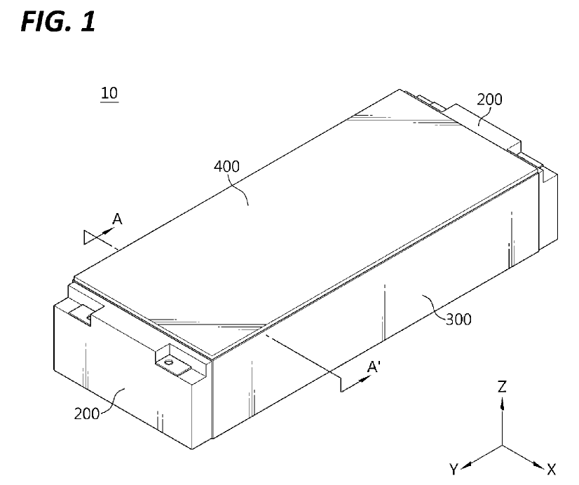

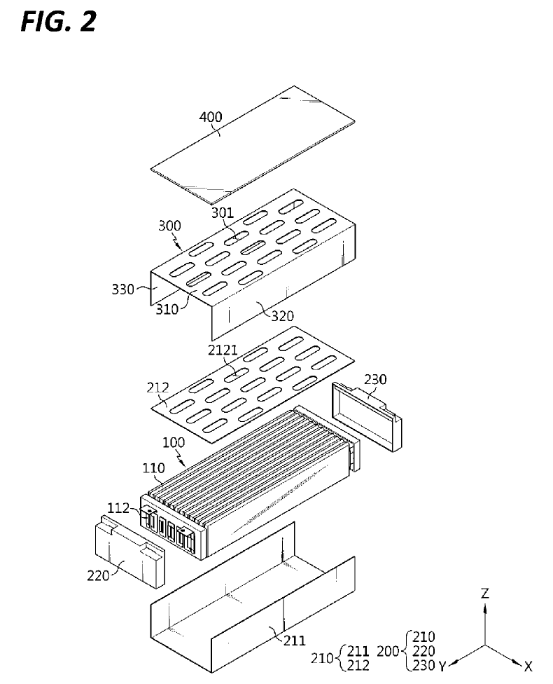

FIG. 1 is a front perspective view of a battery module, according to an embodiment of the present disclosure. FIG. 2 is an exploded perspective view of the battery module, according to an embodiment of the present disclosure.

Referring to FIGS. 1 and 2, a battery module 10, according to an embodiment of the present disclosure, may include a cell stack 100, a case 200, a flexible cover 300, and a hard cover 400.

The cell stack 100 may include a battery cell 110. A plurality of battery cells 110 may be provided. In this case, the plurality of battery cells 110 may be electrically connected to one another.

The plurality of battery cells 110 may be stacked in a direction. For example, as illustrated in FIG. 2, the plurality of battery cells 110 may be arranged side by side in a left-right direction (e.g., X-axis direction) in a state of being erected in a vertical direction (e.g., Z-axis direction).

The plurality of battery cells 110 may include an electrode assembly and a cell case (e.g., a pouch exterior material) accommodating the electrode assembly. The cell case may be a laminate sheet including a resin layer and a metal layer.

In addition, each of the plurality of battery cells 110 may include an electrode lead 112. The electrode lead 112 may be connected to the electrode assembly, may be drawn out to the outside of the cell case, and may function as an electrode terminal.

The electrode leads 112 may be provided in pairs, and the pairs of electrode leads 112 may be drawn out in the length direction (e.g., Y-direction) from opposite ends of respective battery cells 110. The electrode leads 112 may be configured to protrude toward a front side and/or a rear side of a sealing portion of the battery cells 110. In this case, each pair of electrode leads 112 may be a positive electrode lead and a negative electrode lead.

Meanwhile, the present disclosure is not limited by a specific type or shape of the battery cells 110, and various battery cells 110 known at the time of filing of the present disclosure may be employed to constitute the battery module 10 of the present disclosure. In the present embodiment, pouch-type secondary batteries, which have high energy density and are easy to stack, are illustrated as target battery cells, but it is needless to say that cylindrical secondary batteries or prismatic secondary batteries may be applied as the battery cells 110.

The case 200 may be configured to accommodate the cell stack 100. For example, an accommodation space may be formed in the case 200, and the cell stack 100 may be configured to be accommodated in the accommodation space. The case 200 may be made of a metal material having rigidity and heat resistance so as to physically or chemically protect the accommodated cell stack 100.

Referring to FIGS. 1 and 2, the case 200 may include a case body 210, a front end cover 220, and a rear end cover 230.

The case body 210 may include a U-frame 211 and a top plate 212. The U-frame 211 may include a pair of side plates that cover left and right surfaces of the cell stack 100, and a base plate that covers a lower surface of the cell stack 100. The pair of side plates and the base plate may be integrally formed.

The top plate 212 may be configured to cover an upper surface of the cell stack 100. The top plate 212 may be coupled to the U-frame 211 by welding. The case body 210 may be formed in a rectangular tubular shape having open front and rear sides. As an alternative example of the present embodiment, a mono-frame type case 200 in which the U-frame 211 and the top plate 212 are integrally formed may be employed.

The front end cover 220 and the rear end cover 230 may be respectively coupled to the open front side and rear side of the case body 210. The front end cover 220 and the rear end cover 230 may be coupled to the case body 210 by welding or a snap-fit coupling structure.

The top plate 212 may include at least one first venting portion 2121 configured to discharge venting gas. The first venting portion 2121 may be configured to discharge venting gas generated from the battery cells 110 to the outside of the case 200. Directional venting in a single direction may be enabled by the first venting portion 2121.

A plurality of first venting portions 2121 may be provided. The plurality of first venting portions 2121 may be provided at predetermined intervals in a horizontal direction (e.g., X-axis direction or Y-axis direction). The first venting portions 2121 may be arranged side by side while being aligned in a width direction (e.g., X-axis direction) and/or a length direction (e.g., Y-axis direction). The first venting portions 2121 may be formed to extend in the length direction. However, a size, shape, and/or arrangement of the first venting portions 2121 is not limited to the above-described embodiment and may be variously modified.

According to an embodiment, referring to FIG. 2, the first venting portions 2121 may be venting holes.

According to another embodiment, although not illustrated in the drawings, the first venting portions 2121 may be configured to be easily fractured when venting gas is discharged from the battery cells 110. For example, the first venting portions 2121 may include a fracture lines or pre-cut lines configured to be fractured by an explosion pressure. For example, the first venting portions 2121 may have a smaller thickness or a lower density than a surrounding region of the top plate 212, so that fracture may be more easily induced than in the surrounding region.

According to the above-described embodiment of the present disclosure, in a situation in which, for example, gas is generated due to thermal runaway of any one of the plurality of battery cells 110, high-temperature venting gas may be rapidly discharged to the outside of the battery module 10 through the first venting portions 2121. In addition, an upward directional venting from the battery module 10 may be induced through the first venting portions 2121.

The flexible cover 300 may be disposed on the case 200. The flexible cover 300 may be configured to suppress the venting gas or flame discharged when a thermal event occurs in the battery module 10 from propagating to another battery module 10. In addition, the flexible cover 300 may serve as a structure for protecting the battery module 10 from, for example, external venting gas. The flexible cover 300 may have an excellent heat resistance and pressure resistance so as to delay or minimize the thermal runaway.

The flexible cover 300 may include at least one second venting portion 301 configured to discharge venting gas. The second venting portion 301 may be formed at a position corresponding to the first venting portion 2121. The second venting portion 301 and the first venting portion 2121 may be configured to communicate with each other in the vertical direction (e.g., Z-axis direction). The second venting portion 301 may be configured to discharge venting gas discharged through the first venting portion 2121 to the outside of the battery module 10.

A plurality of second venting portions 301 may be provided. The plurality of second venting portions 301 may be provided at predetermined intervals in the horizontal direction (e.g., X-axis direction or Y-axis direction). The second venting portions 301 may be arranged side by side while being aligned in the width direction (e.g., X-axis direction) and/or the length direction (e.g., Y-axis direction). The second venting portions 301 may be formed to extend in the length direction. However, the size, shape, and/or arrangement of the second venting portion 301 is not limited to the above-described embodiment and may be variously modified.

Referring to FIG. 2, the second venting portions 301 may be venting holes. Due to the material characteristics, the flexible cover 300 may have higher ductility than the hard cover 400, and may be less likely to fracture even under high temperature and high pressure. According to the above-described embodiment of the present disclosure, the holes for venting may be formed in the second venting portions 301, so that the venting gas or flame generated from the battery cells 110 inside may be guided to be rapidly and directionally vented to the upward direction of the battery module 10.

Referring to FIGS. 1 and 2, the hard cover 400 may be disposed on the flexible cover 300. The hard cover 400 may cover an upper side of the battery module 10. The hard cover 400 may cover the first venting portions 2121 and the second venting portions 301.

For example, the hard cover 400 may be configured to prevent or suppress the venting gas or flame discharged from another battery module 10 from flowing into the inside of the case 200 through the first venting portions 2121 and the second venting portions 301.

According to the above-described embodiment of the present disclosure, the hard cover 400 may be configured to effectively suppress the venting gas or flame discharged when a thermal event occurs in the battery module 10 from propagating to another battery module 10. In addition, the hard cover 400 may serve as a structure for protecting the battery module 10 from, for example, external venting gas.

The hard cover 400 and/or the flexible cover 300 may be formed of a material having excellent heat resistance and/or fire resistance such as a mica sheet or a silicone composite material. At least one of the hard cover 400 and the flexible cover 300 may include a mica material. For example, the hard cover 400 may be provided as a non-flexible material by thermoforming a mica sheet.

Accordingly, even when high-temperature heat is generated, deformation may not occur in the hard cover 400 and/or the flexible cover 300, so that the shape stability may be maintained, and high-temperature gas or flame generated from the battery cell 110 may be reliably blocked.

According to the above-described embodiment of the present disclosure, the deformation caused by the high-temperature gas or flame may be minimized as the hard cover 400 and/or the flexible cover 300 are provided as a rigid and heat-resistant material.

According to an embodiment of the present disclosure, the hard cover 400 may be made of a material having a higher hardness than the flexible cover 300. Accordingly, the hard cover 400 may be relatively more rigid and may protect the inside of the battery module 10 from external pressure or high temperature. In addition, the flexible cover 300 may be relatively easy to bend and may protect relatively vulnerable edge portions or connection portions from external pressure or high temperature.

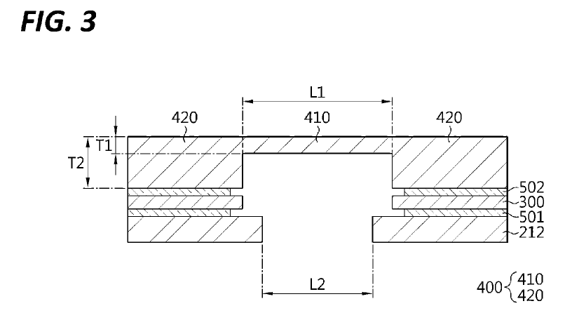

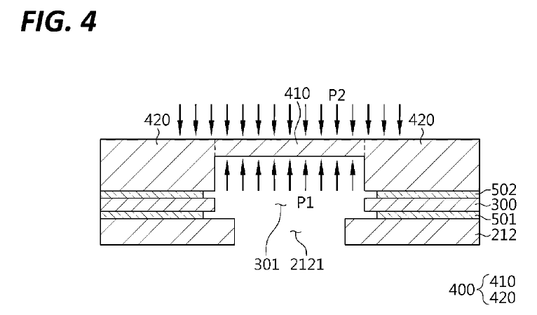

FIG. 3 is a cross-sectional view of the battery module of FIG. 1 taken along the line A-A′. FIG. 4 is a view illustrating a state where the pressure of venting gas is applied in FIG. 3.

The hard cover 400 may be divided into a plurality of regions having different thicknesses. For example, uneven portions may be formed on the hard cover 400. For example, a stepped portion may be formed on the hard cover 400.

The hard cover 400 may be divided into a first region 410 and a second region 420 having different thicknesses.

The first region 410 may be a region corresponding to a first venting portion 2121 and a second venting portion 301, and the second region 420 may be a remaining region except for the first region 410. The first region 410 may be disposed vertically with respect to the first venting portions 2121 and the second venting portions 301. The first region 410 may cover an upper side of the first venting portion 2121 and the second venting portion 301. In addition, the first region 410 may be surrounded by the second region 420.

The second region 420 may face the flexible cover 300. The second region 420 may be in surface contact with the flexible cover 300. The second region 420, the flexible cover 300, and the top plate 212 may be sequentially stacked in the vertical direction.

The first region 410 may have a first thickness T1, and the second region 420 may have a second thickness T2 that is greater than the first thickness T1. In this case, the first region 410 may have a smaller thickness than the second region 420 and may be relatively easily fractured.

Accordingly, according to the above-described embodiment of the present disclosure, while primarily blocking the inflow of, for example, external venting gas, the first region 410 may be formed to be easily fractured so that, for example, the internal venting gas may be rapidly discharged to the outside when a thermal event occurs in the battery cell 110.

The lower surface of the hard cover 400, which faces the flexible cover 300, may be formed such that the first region 410 is recessed toward an upward direction relative to the second region 420.

In addition, the upper surface of the hard cover 400, which is opposite to the surface facing the flexible cover 300, may be formed as a flat surface. For example, the upper surface of the hard cover 400 may be flat, and a stepped portion may be formed on the lower surface.

According to the above-described embodiment of the present disclosure, the hard cover 400 may have different pressure-receiving areas and surface pressures from, for example, venting gas on its upper and lower surfaces.

For example, when a thermal event occurs in the battery cell 110 inside the battery module 10, the venting gas generated inside the battery module 10 may pass through the first venting portion 2121 and the second venting portion 301, and may impinge on the hard cover 400. In this case, the venting gas may be blocked by the hard cover 400, and pressure may be generated, which may be defined as a first pressure P1 (e.g., an open pressure). The first pressure P1 may act in an upward direction (or an outward direction).

The first pressure P1 may be a critical pressure at a time point when, as an internal pressure increases due to thermal runaway or gas generation inside a secondary battery, a discharge structure, such as a cap assembly, a safety vent, or the first region 410 provided in the hard cover 400 of the present disclosure, is physically opened and begins to discharge internal gas to the outside. For example, the first pressure P1 may be a venting pressure that is conventionally used in the related technical field.

In this case, referring to FIG. 4, only the lower surface of the hard cover 400 may be subjected, in the first region 410, to a pressure (e.g., the first pressure P1) of the venting gas discharged outward of the battery module 10. Since the first region 410 is located above the first venting portion 2121 and the second venting portion 301, the first region 410 may directly receive the first pressure P1 when a thermal event occurs. The first pressure P1 may act only on the first region 410 of the hard cover 400. The first pressure P1 may be concentrated on the first region 410 of the hard cover 400.

In the meantime, since the second region 420 does not face the first venting portion 2121 or the second venting portion 301, the first pressure P1 may not be directly applied to the second region 420. In addition, since the second region 420 is in surface contact with the flexible cover 300, the first pressure P1 may not be applied to the second region 420.

According to the above-described embodiment of the present disclosure, by reducing a contact area with the first pressure P1, a surface pressure may be increased so that the first region 410 of the hard cover 400 is induced to be ruptured more quickly.

For example, a thermal event may occur in an adjacent battery module 10, or venting gas discharged to the outside may again be directed toward the inside of the battery module 10. In this case, the venting gas may be blocked by the hard cover 400, and pressure may be generated, which may be defined as a second pressure P2 (e.g., a reverse pressure). The second pressure P2 may act in a downward direction (or an inward direction).

The second pressure P2 may refer to a pressure applied from an outer surface of a battery case toward an inner direction by high-pressure gas or a shock wave caused by, for example, thermal runaway, fire, or explosion of an adjacent battery outside the battery. For example, the second pressure P2 may have a direction opposite to an internal pressure generated inside the battery and may refer to an external pressure that is conventionally used in the related technical field. Alternatively, the second pressure P2 may be a critical pressure at a time point when a discharge structure, such as the first region 410 provided in the hard cover 400 of the present disclosure, is physically opened and external gas begins to flow into the inside.

In this case, the pressure of the venting gas flowing inward from the outside of the battery module 10 may be applied to both the first region 410 and the second region 420 of the upper surface of the hard cover 400. In other words, the second pressure P2 may be distributed not only to the first region 410 but also to the second region 420. The second pressure P2 may act uniformly on the first region 410 and the second region 420.

From this viewpoint, a contact area between the venting gas flowing outward from the inside of the battery module 10 and the hard cover 400 may be smaller than a contact area between venting gas flowing inward from the outside of the battery module 10 and the hard cover 400.

In addition, the surface pressure applied to the hard cover 400 by venting gas flowing outward from the inside of the battery module 10 may be configured to be higher than the surface pressure applied to the hard cover 400 by venting gas flowing inward from the outside of the battery module 10.

For example, when it is assumed that the same amount of venting gas approaches from both the outside and the inside of the battery module 10, the venting gas flowing in from the outside of the battery module 10 may contact a relatively larger area. Accordingly, the pressure acting per unit area (e.g., a surface pressure) may become further lower. In addition, the venting gas flowing outward from the inside of the battery module 10 may contact a relatively smaller area. Accordingly, the pressure acting per unit area (e.g., a surface pressure) may become further higher.

Meanwhile, an upper side of the battery cells 110 may be protected by the top plate 212, the flexible cover 300, and the hard cover 400. In this case, the top plate 212, the flexible cover 300, and the hard cover 400 may be adhesively coupled to one another. According to an embodiment, the battery module 10 according to the present disclosure may further include a first adhesive member 501 disposed between the top plate 212 and the flexible cover 300, and a second adhesive member 502 disposed between the flexible cover 300 and the hard cover 400.

The first adhesive member 501 and/or the second adhesive member 502 may include, for example, an adhesive or an adhesive tape. For example, the first adhesive member 501 and/or the second adhesive member 502 may be a thermally conductive adhesive.

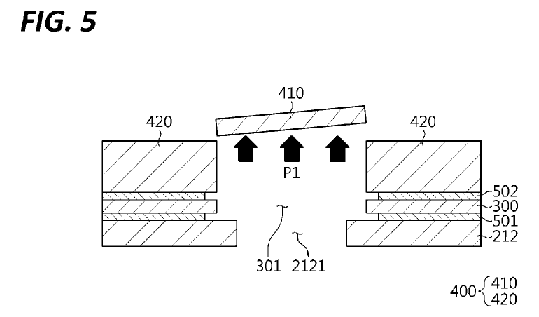

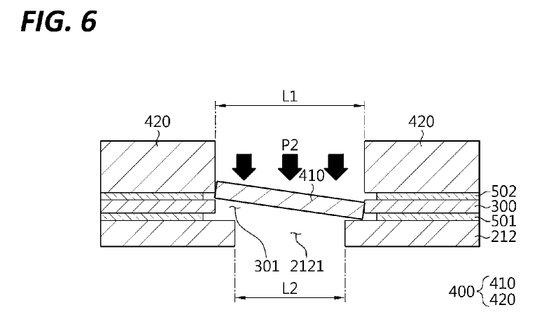

FIG. 5 is a view illustrating a state where a first pressure is applied to the battery module according to an embodiment of the present disclosure. FIG. 6 is a view illustrating a state where a second pressure is applied to the battery module according to an embodiment of the present disclosure.

The first region 410 of the hard cover 400 may be configured to be separated from the second region 420 when a thermal event occurs in the battery cell 110. The first region 410 may be more vulnerable to pressure than the second region 420. The first region 410 may be more easily fractured than the second region 420.

In this case, a rupture occurrence rate of the first region 410 due to the first pressure P1 may be higher than a rupture occurrence rate thereof due to the second pressure P2. When the first pressure P1 is applied to the first region 410, the first region 410 may be more easily fractured under a smaller pressure as compared to when the second pressure P2 is applied.

According to the above-described embodiment of the present disclosure, when the second pressure P2 is applied, a rupture occurrence rate of the hard cover 400 may be reduced, and when the first pressure P1 is applied, a rupture occurrence rate of the hard cover 400 may be increased.

Accordingly, the high-temperature gas or flame generated inside the battery module 10 may be rapidly discharged to the outside. At the same time, the back-flow of the high-temperature gas or flame from the outside into the inside of the battery module 10 may be prevented or suppressed, so that the gas or flame generated in a battery module 10 in which a thermal event occurs may be prevented or delayed from propagating to an adjacent battery module 10 and causing thermal runaway.

Referring to FIG. 6, when the first region 410 is separated from the second region 420, the first region 410 may be configured to cover at least a portion of the first venting portion 2121 when moving downward.

For example, when the first region 410 is ruptured as the second pressure P2 is applied thereto, the separated first region 410 may fall in a downward direction.

In addition, for example, when the first region 410 is separated from the second region 420 by an external pressure, and the first region 410, which is separated from the second region 420, moves downward, the first region 410 may be configured to cover at least a portion of the first venting portion 2121.

Further, although not illustrated in the drawings, even when the first region 410 is ruptured as the first pressure P1 is applied thereto, the separated first region 410 may move upward by the first pressure P1 and may then fall again. In this case, the first region 410 that has fallen downward may cover at least a portion of the first venting portion 2121.

According to the above-described embodiment of the present disclosure, even when the hard cover 400 is ruptured, the separated first region 410 may cover the first venting portion 2121, so that back-inflow of high-temperature gas or flame from the outside into the inside of the battery module 10 may be prevented or suppressed. Accordingly, gas or flame generated in a battery module 10 in which a thermal event occurs may be prevented or delayed from propagating to an adjacent battery module 10 and causing thermal runaway.

Referring primarily to FIG. 6, the first region 410 may have a size larger than the size of the first venting portion 2121. The diameter L1 of the first region 410 may be greater than the diameter L2 of the first venting portion 2121. Here, the diameter L1 of the first region 410 and the diameter L2 of the first venting portion 2121 may be diameters measured in a width direction, or may be diameters measured in a length direction.

According to the above-described embodiment of the present disclosure, the first region 410 separated from the second region 420 may be seated on the top plate 212, rather than penetrating through the first venting portion 2121. The first region 410 separated from the second region 420 may contact a portion of the top plate 212. The first region 410 separated from the second region 420 may contact a surface of the top plate 212 surrounding the first venting portion 2121.

The second venting portion 301 may have a size larger than the size of the first venting portion 2121. The size of the second venting portion 301 may be substantially equal to or larger than the size of the first region 410. For example, referring to FIG. 6, the size of the second venting portion 301 may be substantially equal to the size of the first region 410. According to the above-described embodiment of the present disclosure, when the separated first region 410 falls downward, the first region 410 may not be caught by the second venting portion 301. However, the size of the second venting portion 301 is not limited to the above-described embodiment.

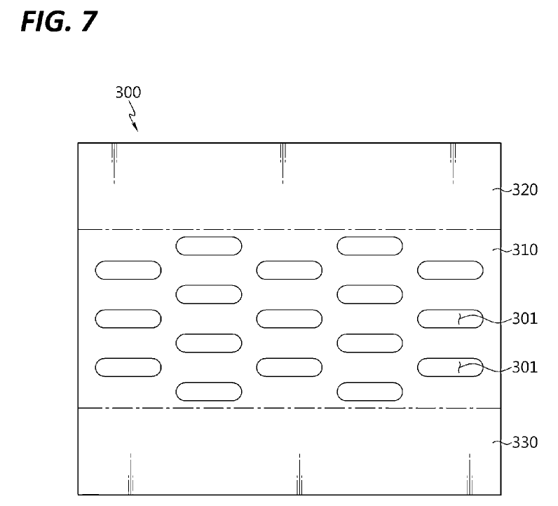

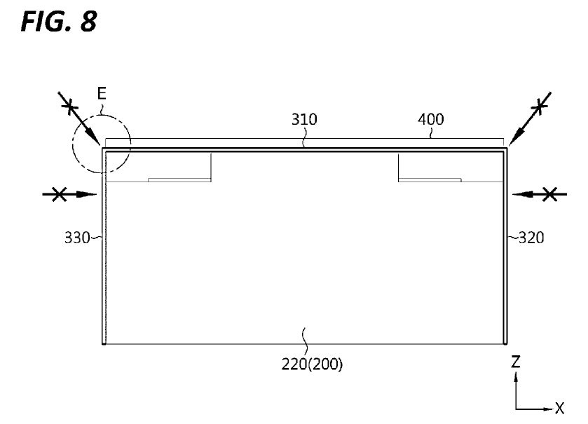

FIG. 7 is an unfolded view illustrating a state where a flexible cover of a battery module, according to an embodiment of the present disclosure, is unfolded. FIG. 8 is a view illustrating a front view of the battery module, according to an embodiment of the present disclosure.

The flexible cover 300 may be configured to cover at least three surfaces of the case 200. The flexible cover 300 may be bendable. The flexible cover 300 may include an upper cover 310, a right cover 320, and a left cover 330. In this case, the upper cover 310, the right cover 320, and the left cover 330 may be integrally formed. The flexible cover 300 may have a U-frame shape.

The upper cover 310 may cover an upper side of the case 200, and the second venting portions 301 may be formed in the upper cover 310. The second venting portions 301 in FIG. 7 may be substantially the same as the second venting portions 301 in FIGS. 2 to 6.

The left cover 330 may extend from the upper cover 310 so as to be bendable and may cover the left side of the case 200. The right cover 320 may extend from the upper cover 310 so as to be bendable and may cover a right side of the case 200.

The hard cover 400 may be able to prevent or suppress back-inflow of external high-temperature gas or flame from an upper side, but may not be able to prevent or suppress inflow of external high-temperature gas or flame flowing in from a lateral side. According to the above-described embodiment of the present disclosure, referring to a portion indicated by reference E in FIG. 8, inflow of external high-temperature gas or flame from a side surface and/or from a boundary portion between an upper surface and a side surface may be prevented or suppressed by the flexible cover 300. Since the battery module 10 according to the present disclosure may include not only the hard cover 400 but also the bendable flexible cover 300, the battery cells inside the battery module 10 may be effectively protected from venting gas outside the battery module 10.

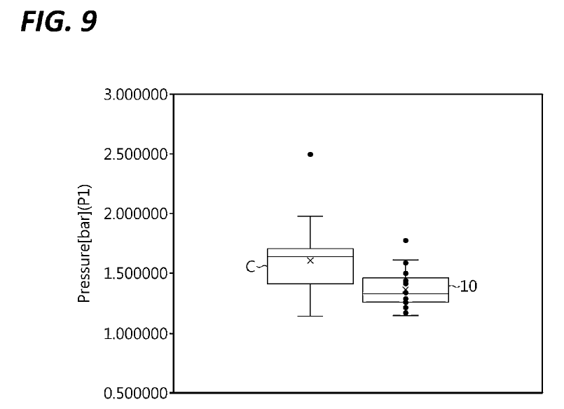

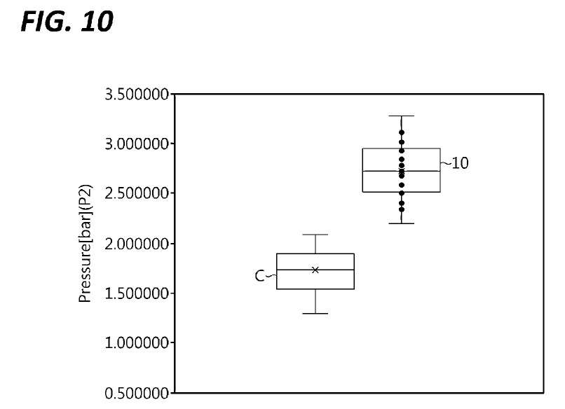

FIG. 9 is a graph illustrating a range of pressures at which a hard cover is ruptured when the first pressure is applied to a battery module, in a comparative example battery module and a battery module according to the present disclosure. FIG. 10 is a graph illustrating a range of pressures at which a hard cover is ruptured when the second pressure is applied to a battery module, in a comparative example battery module and a battery module according to the present disclosure.

A comparative example battery module C is different only in that it does not include the flexible cover 300 and the hard cover 400 as in the battery module 10, according to the present disclosure. For example, unlike the hard cover 400 of the present disclosure, the cover of the comparative example battery module C is not divided into a plurality of regions having different thicknesses. For example, in the comparative example battery module C, the cover that covers a venting hole formed in a case is not disposed at an outermost position. In other words, in the cover of the comparative example battery module C, a contact area between venting gas flowing outward from the inside of the battery module and the cover is not smaller than a contact area between venting gas flowing inward from the outside of the battery module and the cover.

Referring to FIG. 9, in the comparative example battery module C, the cover corresponding to the hard cover 400 of the present disclosure is fractured at a pressure ranging from about 1.1 bar to about 2.0 bar. On average, in the comparative example battery module C, the cover corresponding to the hard cover 400 of the present disclosure is fractured at a pressure ranging from about 1.3 bar to about 1.8 bar.

In contrast, in the battery module 10 of the present disclosure, the hard cover 400 is fractured at a pressure ranging from about 1.1 bar to about 1.7 bar. On average, in the battery module 10 of the present disclosure, the hard cover 400 is fractured at a pressure ranging from about 1.25 bar to about 1.5 bar.

When the first pressure P1 is applied, it may be identified that, in the battery module 10 including the flexible cover 300 and the hard cover 400 according to the embodiment of the present disclosure, the hard cover 400 is ruptured even by a lower pressure. Accordingly, the high-temperature gas or flame generated in the battery cell 110 inside the battery module 10 may be rapidly discharged to the outside. As a result, safety and reliability of the battery module 10 may be further enhanced.

Referring to FIG. 10, in the comparative example battery module C, a cover corresponding to the hard cover 400 of the present disclosure is fractured at a pressure ranging from about 1.2 bar to about 2.1 bar. On average, in the comparative example battery module C, the cover corresponding to the hard cover 400 of the present disclosure is fractured at a pressure ranging from about 1.5 bar to about 1.9 bar.

In contrast, in the battery module 10 of the present disclosure, the hard cover 400 is fractured at a pressure ranging from about 2.1 bar to about 3.4 bar. On average, in the battery module 10 of the present disclosure, the hard cover 400 is fractured at a pressure ranging from about 2.5 bar to about 3.0 bar.

When the second pressure P2 is applied, it may be identified that, in the battery module 10 including the flexible cover 300 and the hard cover 400 according to the embodiment of the present disclosure, the hard cover 400 is ruptured at a higher pressure. Accordingly, the inflow of external high-temperature gas or flame into the inside of the battery module may be maximally prevented or suppressed, and the propagation of gas or flame from a battery module in which an event occurs to an adjacent battery module, thereby causing thermal runaway, may be effectively prevented or delayed.

In view of the foregoing, when a thermal event occurs, the battery module 10 of the present disclosure may rapidly discharge high-temperature and/or high-pressure venting gas from the inside to the outside, while preventing or delaying inflow of external venting gas into the inside, thereby delaying the thermal runaway.

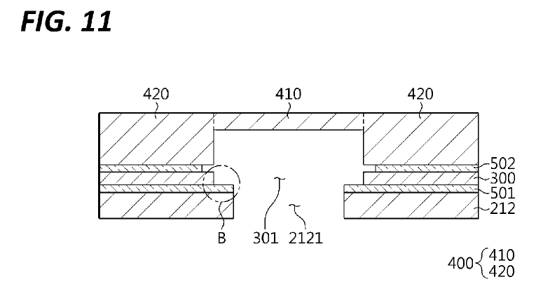

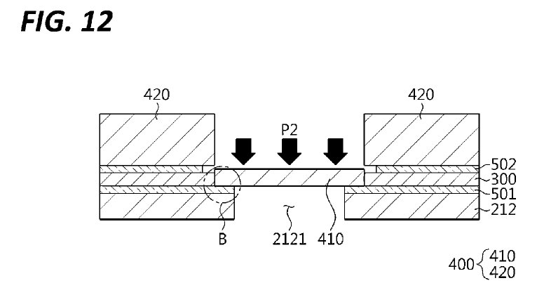

FIG. 11 is a cross-sectional view illustrating an upper side of a battery module according to another embodiment of the present disclosure, taken along line A-A′ of FIG. 1. FIG. 12 is a view illustrating a state where the second pressure is applied to the battery module according to another embodiment of the present disclosure.

Referring to FIG. 11, the first adhesive member 501 may be applied not only to a region corresponding to the flexible cover 300, but also to an entire region corresponding to the top plate 212 of the case 200. Since the first venting portion 2121 provided in the top plate 212 may have a size smaller than the second venting portion 301 provided in the flexible cover 300, a surface of the top plate 212 excluding the first venting portion 2121 may have a larger area than a surface of the flexible cover 300 excluding the second venting portion 301. The first adhesive member 501 may be applied not only to a portion facing the flexible cover 300, but also to a surface of the top plate 212 that protrudes from the flexible cover 300.

Referring to the portions indicated by reference B in FIGS. 11 and 12, when the hard cover 400 is ruptured and the first region 410 is separated from the second region 420 and falls downward, at least a portion of the separated first region 410 may be adhered to the top plate 212 by the first adhesive member 501. Accordingly, the separated first region 410 may be fixed on the top plate 212 in position without being shaken due to, for example, external pressure.

When, upon occurrence of a thermal event, the separated first region 410 shakes in a vertical direction or a horizontal direction due to, for example, external pressure, stability may deteriorate, and it may be difficult to prevent external venting gas from flowing into the inside. According to the above-described embodiment of the present disclosure, since the position of the separated first region 410 may be fixed on the top plate 212, stability of the battery module 10 may be maintained even after the hard cover 400 is ruptured. In addition, according to the above-described embodiment of the present disclosure, the separated first region 410 may be formed to stably cover the first venting portion 2121, which may contribute to preventing external venting gas from flowing into the inside.

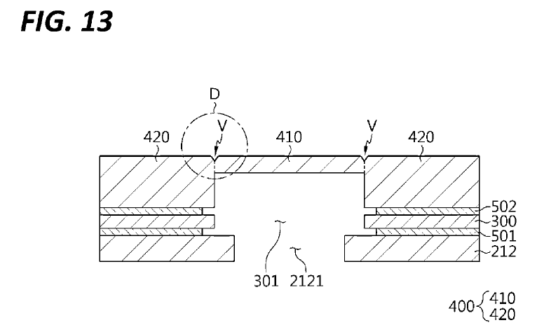

FIG. 13 is a cross-sectional view illustrating an upper side of a battery module according to another embodiment of the present disclosure, taken along the line A-A′ of FIG. 1.

Referring to the portion indicated by reference D in FIG. 13, a fracture portion V may be formed between the first region 410 and the second region 420 of the hard cover 400. The fracture portion V may be formed on the upper surface of the hard cover 400. The fracture portion V may be formed along the boundary surface between the first region 410 and the second region 420. For example, the fracture portion V may include a fracture line or a score line configured to be fractured by a burst pressure. For example, the fracture portion V may have a closed-loop shape. For example, the fracture portion V may be formed to have a locally smaller thickness than a peripheral region of the hard cover 400, so that fracture may be facilitated.

When the first pressure P1 and/or the second pressure P2 is applied to the hard cover 400, the first region 410 may be separated from the second region 420.

According to the above-described embodiment of the present disclosure, since the hard cover 400 is provided with the fracture portion V so as to induce fracture of the fracture portion V, a fracture surface of the fractured first region 410 may be formed more evenly. In view of the fact that, when a fracture surface of the first region 410 is uneven, damage may be caused to the flexible cover 300, the above-described embodiment of the present disclosure may minimize damage to other components inside the battery module 10, including the flexible cover 300.

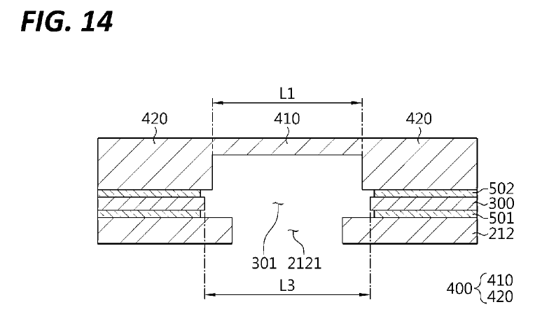

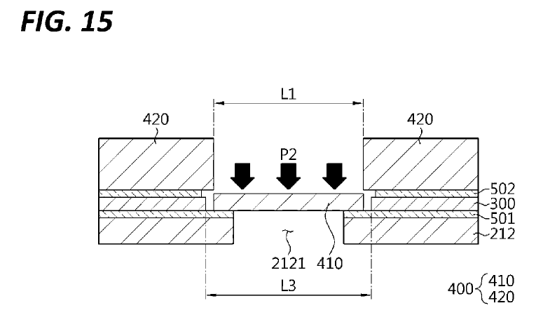

FIG. 14 is a cross-sectional view illustrating an upper side of a battery module according to still another embodiment of the present disclosure, taken along the line A-A′ of FIG. 1. FIG. 15 is a view illustrating a state where the second pressure is applied to the battery module, according to still another embodiment of the present disclosure.

The second venting portions 301 may have a size larger than the size of the first region 410. The diameter L3 of the second venting portions 301 may be greater than the diameter L1 of the first region 410. Here, the diameter L1 of the first region 410 and the diameter L3 of the second venting portions 301 may be diameters measured in a width direction or diameters measured in a length direction.

The first region 410 separated from the second region 420 may pass through the second venting portions 301, and may be seated on the top plate 212. When the separated first region 410 is caught by the flexible cover 300 surrounding the second venting portions 301 while falling downward, the first region 410 may fail to be seated on the top plate 212 in a horizontal state. In this case, external venting gas may not be completely blocked.

According to the above-described embodiment of the present disclosure, when the separated first region 410 falls downward, the first region 410 may be seated on the top plate 212 without being caught by or colliding with the flexible cover 300 surrounding the second venting portions 301. Accordingly, the separated first region 410 may be formed to stably cover the first venting portion 2121, which may contribute to effectively preventing external venting gas from flowing into the inside.

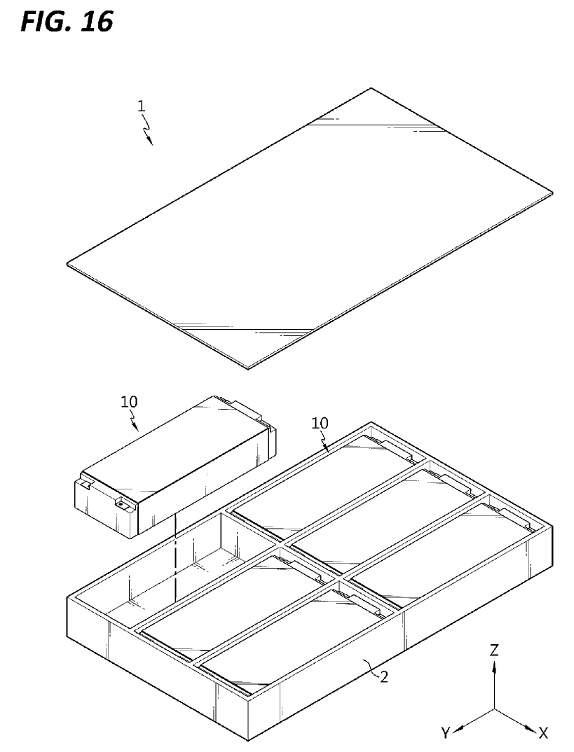

FIG. 16 is a schematic perspective view of a battery pack including a battery module according to an embodiment of the present disclosure.

Referring to FIG. 16, a battery pack 1, according to an embodiment of the present disclosure, may include one or more battery modules 10 according to an embodiment of the present disclosure as described above. The battery pack 1, according to the present disclosure, may further include a pack case 2 configured to accommodate components such as a battery management system (BMS), a current sensor, and a fuse for integrated control of charging and discharging of the one or more battery modules.

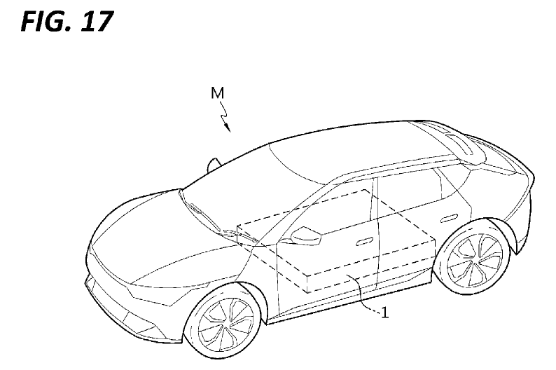

FIG. 17 is a schematic perspective view of a vehicle including a battery pack, according to an embodiment of the present disclosure.

Referring to FIG. 17, a vehicle M, according to an embodiment of the present disclosure, may include one or more battery packs 1 according to an embodiment of the present disclosure, or one or more battery modules 10 according to an embodiment of the present disclosure. The vehicle M according to the present disclosure may be, for example, an electric vehicle, a hybrid electric vehicle, or a plug-in hybrid electric vehicle. The vehicle M may include a four-wheeled vehicle and a two-wheeled vehicle. The vehicle M operates by receiving power from the battery packs 1 or the battery modules 10 according to an embodiment of the present disclosure.

While the present disclosure has been described with reference to the limited embodiments and drawings, the present disclosure is not limited thereto, and various modifications and changes may be made by those skilled in the art of the present disclosure within the technical idea of the present disclosure and the scope equivalent to the claims set forth below.

What is claimed is:

1. A battery module comprising:
a cell stack including a plurality of battery cells;
a case configured to accommodate the cell stack and including a top plate having at least one first venting portion configured to discharge venting gas;
a flexible cover disposed on the case and including at least one second venting portion formed at a position corresponding to the first venting portion and configured to discharge venting gas; and
a hard cover disposed on the flexible cover and divided into a plurality of regions having different thicknesses.

2. The battery module according to claim 1, wherein the hard cover is divided into a first region corresponding to the first venting portion and having a first thickness, and a second region corresponding to a remaining region excluding the first region and having a second thickness greater than the first thickness.

3. The battery module according to claim 2, wherein, on a lower surface of the hard cover facing the flexible cover the first region is recessed upward relative to the second region.

4. The battery module according to claim 3, wherein on the lower surface of the hard cover, pressure of venting gas exiting outward from the battery module is applied only to the first region.

5. The battery module according to claim 2, wherein an upper surface of the hard cover opposite to a surface of the hard cover facing the flexible cover is formed as a flat surface.

6. The battery module according to claim 5, wherein, on the upper surface of the hard cover, pressure of venting gas entering inward from the outside of the battery module is applied to the first region and the second region.

7. The battery module according to claim 2, wherein a contact area between venting gas exiting outward from the inside of the battery module and the hard cover is smaller than a contact area between venting gas entering inward from the outside of the battery module and the hard cover.

8. The battery module according to claim 2, wherein a surface pressure acting on the hard cover by venting gas exiting outward from the inside of the battery module is configured to be higher than a surface pressure acting on the hard cover by venting gas entering inward from the outside of the battery module.

9. The battery module according to claim 2, wherein the first region is configured to be separated from the second region when a thermal event occurs in the battery cell.

10. The battery module according to claim 9, wherein the first region separated from the second region is configured to cover at least a portion of the first venting portion when moved downward.

11. The battery module according to claim 2, wherein the first region is configured to be separated from the second region by an external pressure, and the first region separated from the second region is configured to cover at least a portion of the first venting portion when moved downward.

12. The battery module according to claim 2, wherein the first region has a size larger than a size of the first venting portion.

13. The battery module according to claim 2, wherein at least one of the hard cover and the flexible cover include a mica material.

14. The battery module according to claim 2, wherein the hard cover is formed of a material having a higher hardness than the flexible cover.

15. The battery module according to claim 2, wherein the flexible cover is configured to cover at least three surfaces of the case, thereby protecting the battery cell in the battery module from venting gas outside the battery module.

16. The battery module according to claim 2, wherein the flexible cover includes:
an upper cover that covers an upper side of the case, and having the second venting portion formed therein;
a left cover extending from the upper cover in a bendable manner and configured to cover a left side of the case; and
a right cover extending from the upper cover in a bendable manner and configured to cover a right side of the case.

17. The battery module according to claim 1, further comprising:
a first adhesive disposed between the case and the flexible cover; and
a second adhesive disposed between the flexible cover and the hard cover.

18. The battery module according to claim 1, wherein the second venting portion has a size larger than a size of the first venting portion.

19. A battery pack comprising the battery module according to claim 1.

20. A vehicle comprising the battery module according to claim 1.
